(19) United States
(12) Patent Application Publication
(10) Pub. No.: US 2009/0084880 A1
(43) Pub. Date: Apr. 2, 2009

(54) MAGNETIC TAPE REEL AND MAGNETIC TAPE CARTRIDGE

(75) Inventors: Ren ISHIKAWA, Kanagawa (JP); Katsuhiko Meguro, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/240,033

(22) Filed: Sep. 29, 2008

(30) Foreign Application Priority Data
Sep. 28, 2007 (JP) 2007-256660

(51) Int. Cl. G11B 23/07; G11B 23/037; G11B 23/027; B65H 75/14; B65H 75/18

(52) U.S. Cl. 242/160.3; 242/118.7; 242/610.4; 242/348

(57) ABSTRACT

An aspect of the present invention relates to a magnetic tape reel. The magnetic tape reel comprises a hub on which a magnetic tape is wound, and a flange provided on at least one of upper and lower ends of the hub. The flange comprises a surface coating on at least a portion of a surface thereof on the hub side, the surface coating having a hardness equal to or greater than a hardness of an edge surface of the magnetic tape. A further aspect of the present invention relates to a magnetic tape cartridge comprising a magnetic tape and the magnetic tape reel.

### CROSS-REFERENCE TO RELATED APPLICATIONS

This application claims the benefit of priority under 35 USC 119 to Japanese Patent Application No. 2007-256660 filed on Sep. 28, 2007, which is expressly incorporated herein by reference in its entirety.

### BACKGROUND OF THE INVENTION

1. Field of the Invention

The present invention relates to a magnetic tape reel for winding magnetic tape, and more particularly, to a magnetic tape reel affording a good sliding property with tape edges. The present invention further relates to a magnetic tape cartridge comprising the above magnetic tape reel.

2. Discussion of the Background

The magnetic tape cartridge, comprising a magnetic tape wound on a reel that is housed in a case, for example, is a known external recording medium for computers and the like. One means of stably running a magnetic tape in a magnetic tape cartridge is to regulate tape running with a reel flange. For example, Japanese Unexamined Patent Publication (KOKAI) Heisei No. 11-306714, which is expressly incorporated herein by reference in its entirety, proposes making the gap between the reel flanges close to the width of the tape to achieve the effect of regulating tape running. However, in the method described in Japanese Unexamined Patent Publication (KOKAI) Heisei No. 11-306714, the tape edges are damaged by contact with the flanges. This phenomenon becomes more pronounced when employing a tape that has a base in the form of a reinforcement layer or the like that tends to produce shavings. Accordingly, as a countermeasure, Japanese Unexamined Patent Publication (KOKAI) Heisei No. 10-177775 and Japanese Unexamined Patent Publication (KOKAI) Heisei No. 9-293352, which are expressly incorporated herein by reference in their entirety, propose reducing damage to the tape edge by imparting a sliding property to the reel flange to lower the frictional resistance.

However, using the technique described in Japanese Unexamined Patent Publication (KOKAI) Heisei No. 10-177775, when the surface of a tape base that is equipped with a reinforcement layer, for example, has a high degree of hardness, the surface of the flange ends up being shaved and the shavings adhere to the surface of the tape, potentially causing problems such as damaging the head within the drive. In the configuration in which a sliding sheet is adhered to the flange, as set forth in Japanese Unexamined Patent Publication (KOKAI) Heisei No. 9-293352, there is a problem in that since the sheet is secured, there is a greater tendency for the tape edge surfaces to be damaged than in reels with integrated flanges.

### SUMMARY OF THE INVENTION

An aspect of the present invention provides for a magnetic tape reel that permits good sliding with tape edge surfaces.

The present inventors conducted extensive research into achieving the above-stated magnetic tape reel, resulting in the discovery that abrasion between the edge surface of the tape and the reel flange could be inhibited by providing a member of greater than or equal hardness to the edge surface of the magnetic tape on the surface on which the reel flange contacts with the edge surface of the magnetic tape. The present invention was devised on that basis.

An aspect of the present invention relates to a magnetic tape reel comprising:

a hub on which a magnetic tape is wound; and

a flange provided on at least one of upper and lower ends of the hub, wherein

the flange comprises a surface coating on at least a portion of a surface thereof on the hub side, the surface coating having a hardness equal to or greater than a hardness of an edge surface of the magnetic tape.

A further aspect of the present invention relates to a magnetic tape cartridge comprising a magnetic tape and the above magnetic tape reel.

The magnetic tape may comprise a layer comprising metal and/or ceramic, and the surface coating may comprise metal and/or ceramic.

The surface coating may be a surface coating layer provided on the surface of the flange on the hub side.

The surface coating may be positioned on a surface of a member, the member being molded integrally with the flange by insert molding.

The present invention can minimize abrasion between the edge surface of the tape and the reel flange even when winding a magnetic tape having surfaces of great hardness, such as a base equipped with a reinforcement layer, and inhibit head damage and the like during drive running.

Other exemplary embodiments and advantages of the present invention may be ascertained by reviewing the present disclosure and the accompanying drawings.

### BRIEF DESCRIPTION OF THE DRAWINGS

The present invention will be described in the following text by the exemplary, non-limiting embodiments shown in the figures, wherein:

FIG. 1 is a descriptive drawing of one embodiment of the magnetic tape reel of the present invention.

FIG. 2 is a descriptive drawing of one embodiment of the magnetic tape reel of the present invention.

FIG. 3 is an example of the design of members of greater than or equal hardness to the tape edge surface. The left drawing shows an upper flange. The right drawing shows a lower flange.

FIG. 4 is an example of the design of members of greater than or equal hardness to the tape edge surface. The left drawing shows an upper flange. The right drawing shows a lower flange.

### DETAILED DESCRIPTIONS OF THE EMBODIMENTS

The following preferred specific embodiments are, therefore, to be construed as merely illustrative, and non-limiting to the remainder of the disclosure in any way whatsoever. In this regard, no attempt is made to show structural details of the present invention in more detail than is necessary for fundamental understanding of the present invention; the description taken with the drawings making apparent to those skilled in the art how several forms of the present invention may be embodied in practice.

### Magnetic Tape Reel

The magnetic tape reel of the present invention comprises a hub on which a magnetic tape is wound, and a flange provided on at least one of upper and lower ends of the hub. The flange comprises a surface coating on at least a portion of a surface thereof on the hub side, and the surface coating has a hardness equal to or greater than a hardness of an edge surface of the magnetic tape.

In recent years, to increase the dimensional stability of magnetic tapes, a layer comprising ceramic such as metal and/or metal oxide has been provided on a magnetic tape base as a reinforcement layer. Such magnetic tape bases are disclosed in, for example, Japanese Unexamined Patent Publication (KOKAI) Nos. 2006-216194, 2006-216195, and 2007-26573, which are expressly incorporated herein by reference in their entirety. Since a portion of the reinforcement layer is exposed at the surface of the magnetic tape edge, the surface of the tape edge hardens. The use of the magnetic tape reel of the present invention to wind such a magnetic tape can prevent shaving of the inner flange surface during contact between the inner flange surface and the surface of the magnetic tape edge, prevent shavings from adhering to the tape surface, and prevent the head from being damaged within the drive.

When a magnetic tape having a layer comprising metal and/or ceramic as set forth above is wound onto the magnetic tape reel of the present invention, the above surface coating also desirably comprises metal and/or ceramic. Examples of such materials are alumina and ceramic micropowders. The hardness of the surface coating need only be greater than or equal to that of the surface of the magnetic tape edge. To effectively prevent shaving of the flange, a greater degree of hardness than the surface of the magnetic tape edge is desirable. For example, the hardness of the surface coating is desirably about 9 to 12, as the Mohs' hardness.

The magnetic tape reel of the present invention will be described in greater detail below based on the drawings.

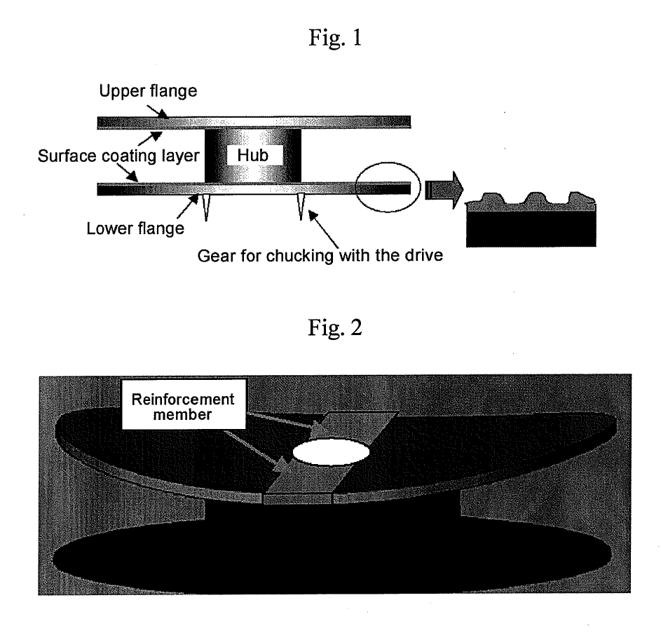

FIG. 1 is a drawing descriptive of an embodiment of the magnetic tape reel of the present invention.

The magnetic tape reel of the present invention comprises, for example, a cylindrical hub on which a magnetic tape can be wound, and a flange on at least one of upper and lower ends of the hub. The flange is provided on at least one of upper and lower ends of the hub, and as shown in FIG. 1, can be provided on both ends of the hub. Hereinafter, the flange provided on the upper end of the hub will be referred to as the “upper flange,” and the flange provided on the lower end of the hub will be referred to as the “lower flange.”

In the embodiment shown in FIG. 1, a surface coating layer is provided on both of the hub-side surfaces (also referred to as the “inner surfaces”) of the upper and lower flanges. The surface coating layer need only be provided on a portion of the flange inner surface, but to effectively prevent damage to the flange, is desirably formed over the entire flange inner surface. The surface coating layer has a hardness of equal to or greater than that of the edge surface of the magnetic tape wound on the hub. Thus, it is possible to prevent shaving of the flange surface during contact between the edge surface of the magnetic tape and the flange inner surface, prevent shavings from adhering to the tape surface, and prevent damaging of the head within the drive.

When the magnetic tape reel of the present invention comprises both upper and lower flanges, it may have a two-piece configuration in which the hub and one of the flanges are a single member, or may have a three-piece configuration in which the hub, upper flange, and lower flange are formed as separate pieces. The surface coating layer may have a hardness that is equal to or greater than that of the edge surface of the magnetic tape that is wound on the magnetic tape cartridge. As set forth above, for example, the harness may be about 9 to 12, as the Mohs' hardness. As shown in FIG. 1, suitable unevenness is desirably imparted to the surface coating layer. The imparting of unevenness to the surface coating can diminish the contact area during contact between the tape edge surface and the flange surface, reducing damage. The surface coating with unevenness desirably has a center surface average roughness Ra of less than 1 micrometer.

Alumina in which hard portions of suitable unevenness are present is desirable as the material of the surface coating. Metal powder or ceramic powder can be admixed to the surface coating to impart unevenness.

The surface coating layer can be formed on the flange surface by a means such as vacuum deposition, plasma CVD, or spraying an aerosol comprised of alumina or ceramic microparticles dispersed in a gas such as nitrogen. When admixing metal or ceramic powder as set forth above, the particles that are admixed can be of the same material as that used to form the surface coating, or of a different material from that used to form the surface coating. In the latter case, a material of greater hardness than the material used to form the surface coating is desirably selected as the material constituting the particles to impart protrusions of great hardness.

The surface coating layer can be about 0.1 to 1 micrometer in thickness, for example. As will be set forth further below, the coating formed on members can also be about 0.1 to 1 micrometer in thickness, for example.

FIG. 1 shows an example of the formation of a coating (surface coating layer) over the entire flange inner surface. However, the surface coating does not necessarily have to be formed over the entire flange surface. A magnetic tape reel in which the surface coating is present on a portion of the flange inner surface will be described below with reference to FIG. 2.

FIG. 2 shows a configuration in which a member is inserted into the upper flange, as an embodiment of the magnetic tape reel of the present invention. In this embodiment, the member is integrally molded with the flange by insert molding. Integrally molding the member and the flange by insert molding in this manner is desirable because there is no need to attach the member with a screw or the like, and any desired shape can be readily formed.

The surface coating can be present on the surface of the portion, that is exposed on the flange inner surface, of the above member; it is not necessary for the surface coating to cover the entire member.

In the embodiment shown in FIG. 2, the member protrudes to the tape edge side from the surrounding flange. Thus, the edge of the tape comes into contact with the portion of the member exposed on the flange inner surface during winding of the magnetic tape. In the above embodiment, it suffices to provide the surface coating on the surface of the portion of the member exposed on the flange inner surface. Such a magnetic tape reel can be more easily manufactured than when imparting coatings to the assembly as shown in FIG. 1.

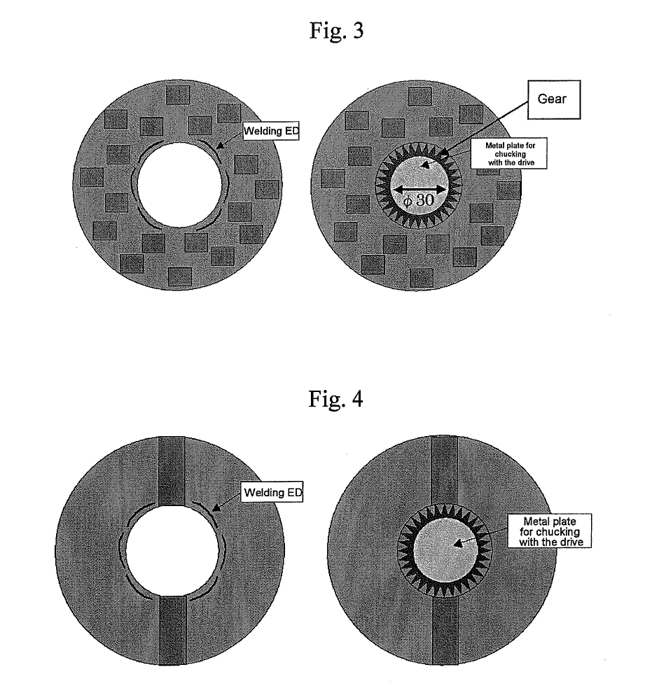

FIG. 2 shows an example where the member is inserted into the upper flange. However, the present invention is not limited to the embodiment shown in FIG. 2. The member may also be provided on just the lower flange, or may be provided on both the upper and lower flanges. FIGS. 3 and 4 show examples of the positioning of the members.

In the embodiment shown in FIG. 3, members are disposed as scattered islands on the inner surfaces of both the upper and lower flanges. In the embodiment shown in FIG. 4, members are disposed linearly in a diametrical direction on the inner surfaces of both the upper and lower flanges. In the embodiments shown in FIGS. 2 and 4, the members on the upper and lower flanges are each comprised of a single member. In the embodiments shown in FIGS. 3 and 4, the upper flange comprises protrusions (welding EDs (energy directors)) for welding to the hub. The lower flange comprises gears required for chucking with the drive, not shown, and a magnetic metal plate (for example, with a diameter of 30 mm, thickness of 1 mm, made of steel) for chucking.

Having continuous members in the diametrical direction of the flange in this manner makes it possible to increase the rigidity of the flange. Disposing the members linearly reduces the frequency of the rotational component of the members during running in a drive, so that even if the rotational component of the members affected tape running, it could be readily tracked with the head. A highly rigid material such as steel or aluminum is desirably employed in the members. This can inhibit upward pressure on the flange (creep deformation) due to trace of winding of the tape, and stabilize the gap between the flanges. The members can be insert molded by known methods.

The magnetic tape reel of the present invention is not specifically limited other than that it comprise the above-described flange. For example, materials employed in common magnetic tape reels can be employed without limitation as the reel material (the material constituting the hub and flange). By way of example, a resin such as polycarbonate can be employed as the reel material. Various forms of the magnetic tape reel of the present invention are possible, such as a form in which the lower flange is welded to a hub integrated with the upper flange. The magnetic tape reel of the present invention can be combined with a tape. The magnetic tape reel of the present invention can also be applied as a machine reel within a drive.

The magnetic tape that is wound onto the magnetic tape reel of the present invention is not specifically limited. A magnetic tape having tape edge surfaces of great hardness is desirably employed. Examples of such magnetic tapes are magnetic tapes comprising a reinforcement layer of metal or ceramic on a tape base (support). An example of the reinforcement layer is a layer comprised of aluminum oxide. Details of such tapes are described, for example, Japanese Unexamined Patent Publication (KOKAI) Nos. 2006-216194, 2006-216195, and 2007-26573. Providing a reinforcement layer can increase the rigidity of the tape and inhibit change in the dimensions of the tape in hot and humid environments.

### Magnetic Tape Cartridge

The present invention further relates to a magnetic tape cartridge comprising the magnetic tape reel of the present invention and a magnetic tape. The magnetic tape cartridge of the present invention can be of a single-reel configuration having just one reel, or of a double-reel configuration having two reels. It is desirably a single-reel cartridge for computer backup in which a high-precision reel form is desirable for high recording density. Details of the magnetic tape and the magnetic tape reel comprised in the magnetic tape cartridge of the present invention are as set forth above. By way of example, the magnetic tape cartridge of the present invention can be configured so that a single reel wound with magnetic tape is housed in rotatable fashion within a case that is of approximately rectangular shape when viewed from above. As for the configuration and the like of the magnetic tape cartridge, reference can be made in, for example, Japanese Unexamined Patent Publication (KOKAI) Nos. 2003-85931, 2007-080326, and 2007-066466, which are expressly incorporated herein by reference in their entirety

### EXAMPLES

The present invention will be described in detail below based on examples. However, the present invention is not limited to the examples.

### Example 1

### Fabrication of a Magnetic Tape Reel

The tape reel shown in FIG. 1 was fabricated. The layer coating had a Mohs' hardness of 10.

### Example 2

### Fabrication of a Magnetic Tape Reel

The tape reel shown in FIG. 4 having members (reinforcement members) on the upper and lower flanges was fabricated. The surface coating provided on the flange inner surface side of the reinforcement members had a Mohs' hardness of 10.

### Example 3

### Fabrication of a Magnetic Tape Cartridge

A magnetic tape having a support comprising a reinforcement layer (single surface thickness of 100 μm) of aluminum oxide on both surfaces of a polyethylene naphthalate (PEN) film 4.8 micrometers in thickness was prepared. Measurement of the hardness of the edge surfaces of the magnetic tape revealed a Mohs' hardness of 9. The magnetic tape was wound onto the hub of the magnetic tape reel fabricated in Example 1 and placed within a case to fabricate a single-reel magnetic tape cartridge.

### Example 4

With the exception that the magnetic tape reel was replaced with the magnetic tape reel fabricated in Example 2, a magnetic tape cartridge was fabricated by the same method as in Example 3.

The magnetic tape reel of the present invention is suitable for use as a magnetic tape reel for backup tapes in which good durability is required.

Although the present invention has been described in considerable detail with regard to certain versions thereof, other versions are possible, and alterations, permutations and equivalents of the version shown will become apparent to those skilled in the art upon a reading of the specification and study of the drawings. Also, the various features of the versions herein can be combined in various ways to provide additional versions of the present invention. Furthermore, certain terminology has been used for the purposes of descriptive clarity, and not to limit the present invention. Therefore, any appended claims should not be limited to the description of the preferred versions contained herein and should include all such alterations, permutations, and equivalents as fall within the true spirit and scope of the present invention.

Having now fully described this invention, it will be understood to those of ordinary skill in the art that the methods of the present invention can be carried out with a wide and equivalent range of conditions, formulations, and other parameters without departing from the scope of the invention or any embodiments thereof.

All patents and publications cited herein are hereby fully incorporated by reference in their entirety. The citation of any publication is for its disclosure prior to the filing date and should not be construed as an admission that such publication is prior art or that the present invention is not entitled to antedate such publication by virtue of prior invention.

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

What is claimed is:

1. A magnetic tape reel comprising:
a hub on which a magnetic tape is wound; and
a flange provided on at least one of upper and lower ends of the hub, wherein
the flange comprises a surface coating on at least a portion of a surface thereof on the hub side, the surface coating having a hardness equal to or greater than a hardness of an edge surface of the magnetic tape.

2. The magnetic tape reel according to claim 1, wherein the magnetic tape comprises a layer comprising metal and/or ceramic, and the surface coating comprises metal and/or ceramic.

3. The magnetic tape reel according to claim 1, wherein the surface coating is a surface coating layer provided on the surface of the flange on the hub side.

4. The magnetic tape reel according to claim 1, wherein the surface coating is positioned on a surface of a member, the member being molded integrally with the flange by insert molding.

5. A magnetic tape cartridge comprising:
a magnetic tape; and
the magnetic tape reel according to claim 1.

6. The magnetic tape cartridge according to claim 5, wherein the magnetic tape comprises a layer comprising metal and/or ceramic, and the surface coating comprises metal and/or ceramic.

7. The magnetic tape cartridge according to claim 5, wherein the surface coating is a surface coating layer provided on the surface of the flange on the hub side.

8. The magnetic tape cartridge according to claim 5, wherein the surface coating is positioned on a surface of a member, the member being molded integrally with the flange by insert molding.
